(19) United States
(12) Patent Application Publication
(10) Pub. No.: US 2025/0245423 A1
(43) Pub. Date: Jul. 31, 2025

(54) SYSTEM AND METHOD FOR DYNAMIC FORM SELECTION AND SYNCHRONIZATION IN A CONVERSATIONAL AI INTERFACE

(71) Applicant: CELLIGENCE INTERNATIONAL LLC, Guaynabo, PR (US)

(72) Inventors: Pavan AGARWAL, DORADO, PR (US); Gabriel Albors SANCHEZ, SAN JUAN, PR (US); Jonathan Ortiz RIVERA, SAN JUAN, PR (US)

(73) Assignee: CELLIGENCE INTERNATIONAL LLC, Guaynabo, PR (US)

(21) Appl. No.: 19/182,453

(22) Filed: Apr. 17, 2025

Related U.S. Application Data
(63) Continuation-in-part of application No. 18/135,703, filed on Apr. 17, 2023.
(60) Provisional application No. 63/332,205, filed on Apr. 18, 2022.

(51) Int. Cl. G06F 40/174; G06F 40/205; G06F 40/35; G06Q 40/03; H04L 9/06

(52) U.S. Cl. CPC G06F 40/174; G06F 40/205; G06F 40/35; H04L 9/0631; G06Q 40/03

(57) ABSTRACT

Systems and methods are provided for dynamically selecting, displaying, and synchronizing electronic forms within a conversational AI interface. A chat-based assistant determines the most contextually relevant form or form section using machine learning models and updates the graphical user interface in a split-screen layout. The system supports bidirectional synchronization, such that changes in form fields generate corresponding chat messages, and chat inputs populate structured form fields in real time. Users may pause and resume form workflows across sessions without data loss. The system further supports folder-based organization of structured inputs and document uploads, enabling hierarchical navigation and predictive workflow continuation. These improvements enhance form completion accuracy, user experience, and operational efficiency.

### RELATED APPLICATIONS

This application a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD

The present disclosure relates to AI-driven conversational interfaces and, more particularly, to systems and methods for dynamically selecting and updating graphical user interfaces (GUI) in synchronization with a chat-based interaction system.

### BACKGROUND

Traditional mortgage and financial application workflows rely on linear, form-based data entry. However, real-world borrower interactions often occur in non-linear conversations, making standard workflows inefficient. The conventional approach requires users to switch between a chat interface and separate application forms, causing disruptions and abandonment of the process.

Existing systems fail to synchronize structured form data with chat-based inputs in real time, dynamically select the most relevant form or form section based on conversation flow, enable bidirectional updates, allowing form changes to trigger chat messages and vice versa, provide a split-screen UI that allows real-time interaction between the chat interface and the graphical form display, or guide the user through form completion using an AI-driven conversational assistant (AA) and/or human assistant (HA).

Accordingly, there is a need for an AI-powered mortgage processing system that integrates dynamic form selection and bidirectional data synchronization within a split-screen chat interface.

### SUMMARY

The disclosed system enables a conversational AI assistant to guide users through electronic form workflows by dynamically selecting, displaying, and updating relevant form sections within a split-screen interface. The assistant leverages machine learning models to analyze conversation context, infer user intent, and prioritize which fields or sections to present. The system supports bidirectional synchronization between a chat interface and a structured graphical form, ensuring that updates in one interface are reflected in the other in real time. Structured inputs—such as loan numbers, account details, or uploaded documents—are categorized and organized into hierarchical folders for intuitive navigation. Users can pause and resume workflows across devices without losing progress, while adaptive assistance mechanisms and real-time sentiment monitoring improve completion rates and reduce user frustration.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIGS. 1A-1B illustrate a conversational AI-driven form optimization system, according to an implementation of the disclosure.

FIG. 2 illustrates an example diagram of a conversational AI-driven form optimization server for an exemplary illustrative conversational AI-driven form optimization system in FIGS. 1A-1B, according to an implementation of the disclosure.

FIGS. 3A-3N illustrate real-time user interactions with an AI assistant within a chat interface of a conversational AI-driven form optimization application of the conversational AI-driven form optimization system of FIGS. 1-2, according to an implementation of the disclosure.

FIG. 4 is a flowchart illustrating a user interaction and workflow example, according to an implementation of the disclosure.

FIG. 5 illustrates an example computing system that may be used in implementing various features of embodiments of the disclosed technology.

Described herein are systems and methods for improving electronic form completion by integrating a conversational AI interface that interacts with users through natural language. The system dynamically selects, renders, and synchronizes structured form fields using predictive models and adaptive workflows. A machine learning-powered AI assistant (AA) guides users through the process, leveraging modular components for form selection, bidirectional synchronization, user satisfaction modeling, and session persistence. In some embodiments, a human assistant (HA) may optionally be engaged when user behavior indicates elevated friction or the need for escalated support. The technical details of example embodiments are set forth below, including system architecture, interface behavior, and interaction workflows. Additional features, objects, and advantages will be apparent to one skilled in the art upon examination of the following description, drawings examples, and claims. It is intended that all such additional systems, methods, features, and advantages be included within this description, be within the scope of the present disclosure, and be protected by the accompanying claims.

### DETAILED DESCRIPTION

The disclosed system enables a conversational AI assistant to dynamically select, display, and update forms or form sections in a split-screen interface, ensuring that user interactions remain intuitive and efficient.

Completing an electronic form (e.g., a financial loan application) may require a variety of user data, including banking details, tax documents, and identification credentials. Users frequently cannot complete the form in one session and may need to pause to locate documents. Existing solutions do not assist users in an effective manner, leading to high abandonment rates. Current chat-based assistants only answer generic queries and do not dynamically adjust to user needs or optimize form workflows based on user input.

Additionally, conventional electronic forms enforce a rigid, sequential workflow, requiring users to enter data in a pre-defined order. If a required field is missing, the user cannot proceed, further complicating the process. Some fields may require the user to input previously provided information again, causing redundancy and frustration.

### System Overview

The presently disclosed system is implemented using a computer-based processing architecture, comprising a distributed cloud-based server executing machine learning models, a local computing device with a chat interface, and a graphical processing module for rendering dynamic UI updates. The processor executes natural language processing (NLP) algorithms to interpret user intent, machine learning models for workflow prediction, and a data synchronization engine to maintain consistency between structured and unstructured data. The system includes, an AI-powered chat interface for natural-language interaction, a dynamic form selection module, utilizing ML algorithms to predict the most relevant form sections, a bidirectional data synchronization engine, ensuring consistency between chat messages and form inputs, a split-screen user interface (UI) that adapts dynamically to conversation flow, and a hybrid AI-human support system, where the AA assists with form completion and escalates user queries to the HA when needed.

The methods and techniques described herein may give rise to various technical effects and advantages.

### Conversational AI-Driven Workflow Optimization

The disclosed system improves the user experience by providing the user with the ability to complete web-based forms through a conversational interface. Instead of following a rigid structure, the AI-powered assistant (AA) interacts with users through natural-language dialogue, eliciting information based on the conversation flow rather than enforcing a strict sequence. In accordance with various embodiments, the disclosed system predicts and displays the most relevant form or section based on ongoing conversation context, ensuring that the user sees only the information relevant to their current discussion.

The system simplifies the process by recognizing when a user is struggling and offering real-time assistance. Further the system provides explanations and clarifications about requested information. Finally, by inviting a human assistant (HA) when the user requires additional support, the system further simplifies the process.

### Bidirectional Synchronization & Split-Screen UI

The chat interface and the graphical form are automatically synchronized, ensuring consistency between conversational inputs and structured data. For example, when a user modifies a field in the form, the system generates a real-time chat message reflecting the update. Conversely, when a user provides information in chat, the corresponding form field is automatically populated. The split-screen layout ensures that users can interact with both interfaces simultaneously, maintaining workflow continuity.

### Human Assistant (HA) Integration

While the AI assistant handles most interactions, the system detects when human assistance is needed. For example, the HA may take over the conversation when the user is struggling. Additionally, the HA may provide contextual guidance based on AI-generated suggestions and modify structured form data to ensure accuracy.

### Session Persistence & Secure Data Handling

Users can pause and resume the form completion process without losing progress. The system maintains session history across multiple devices. Secure chat integration ensures that sensitive data (e.g., SSNs, banking details) is masked within the chat log while allowing seamless communication.

### Intelligent Quick Requests & Categorization

The system introduces quick request elements associated with specific form fields. Users can categorize responses by tagging them with relevant quick request icons. If a user provides information out of sequence, the AI recognizes the context and assigns the data to the correct field.

### Emotional State Recognition & Adaptive Assistance

The AI assistant monitors user sentiment through linguistic cues, response time, and interaction patterns. The system may generate emotional state indicators to help the HA tailor their responses.

### System

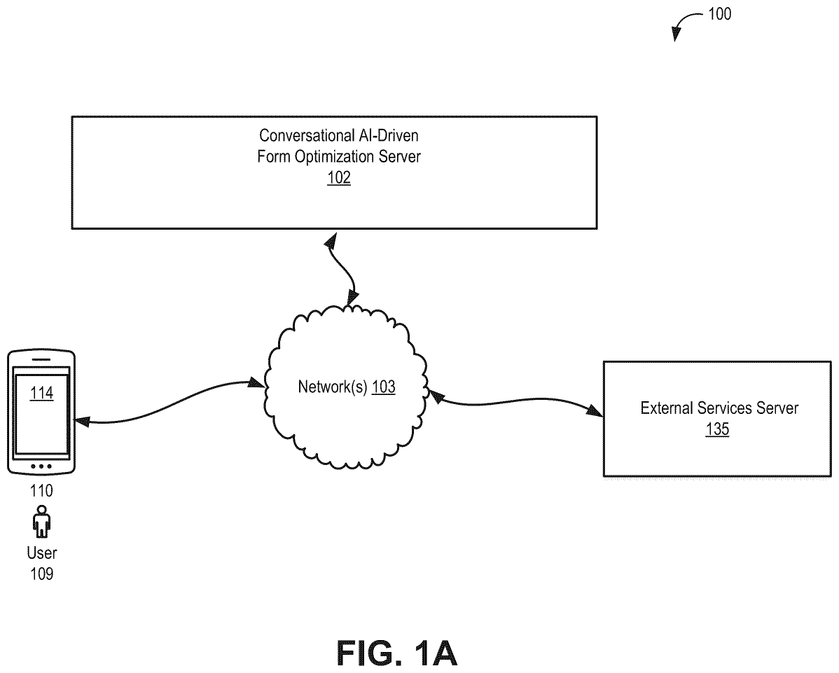

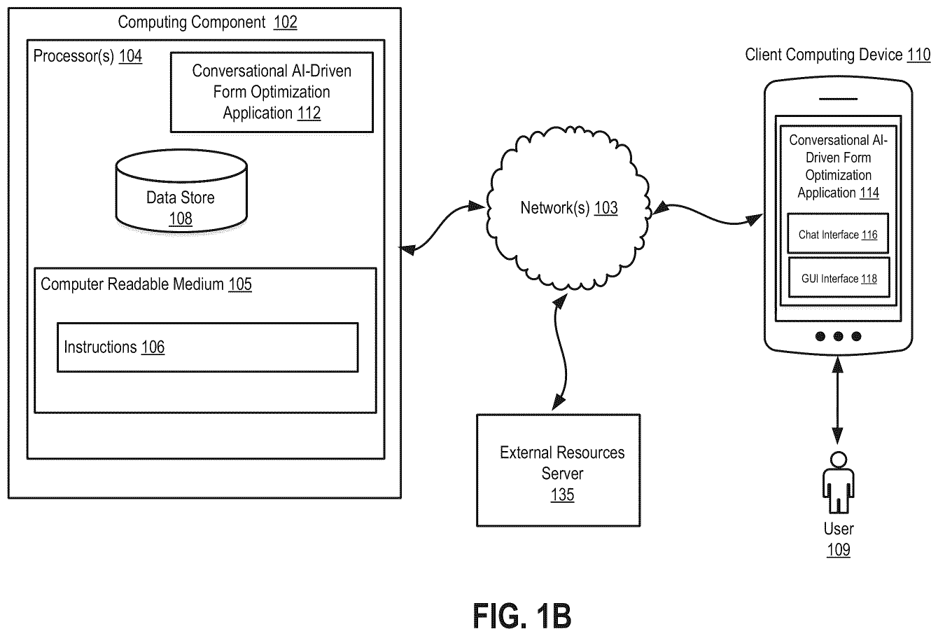

FIG. 1A illustrates an exemplary conversational AI-driven form optimization system 100, in accordance with the embodiments disclosed herein. The conversational AI-driven form optimization system 100 comprises several key components enabling a conversational AI assistant to dynamically select, display, and update forms or form sections in a split-screen interface based on user interaction within a chat environment.

The system 100 includes a conversational AI-driven form optimization server 102, which communicates over network 103 with external resources server(s) 135 and client computing device(s) 110. A user 109 accesses the system through a client computing device 110 running a conversational AI-driven form optimization application 114, which supports chat-based form interaction and dynamic form visualization. Server 102 performs core computational functions, leveraging predictive models and stored form interaction data to select and update relevant forms in real time.

As illustrated in FIG. 1B, the server 102 includes processor(s) 104 configured to execute the form optimization application 112 stored in memory. The application accesses a data store 108 containing models, user data, and historical form records. Processor 104 executes instructions 106 from a computer-readable medium 105 to dynamically manage form selection, synchronization, and chat-based workflow progression.

The form optimization application 112 processes user chat inputs in real time, classifies relevant user data, predicts which form or form section is appropriate, and ensures that both chat messages and form fields are kept synchronized through bidirectional updates. The split-screen interface allows the user to visualize the graphical form while continuing to interact conversationally via the chat interface.

As illustrated in FIG. 1B, computing component or server 102 may be, for example, a server computer, a controller, or any other similar computing component capable of processing data. In the example implementation of FIG. 1B, computing component 102 includes a hardware processor 104 configured to execute one or more instructions residing in a machine-readable storage medium 105 comprising one or more computer program components.

### Hardware Processor 104

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

### Storage Medium 105

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

### Client Computing Device 110

Client computing device 110 serves as the primary interface for user 109 to engage with the form optimization system. The device runs a local instance of the conversational AI-driven form optimization application 114, which includes both a chat interface 116 and a graphical user interface (GUI) 118 for form visualization and interaction. Through this interface, the user may input responses to AI-generated questions, review the auto-populated form, and optionally edit data fields.

The chat interface 116 provides an intuitive dialogue-based approach to form completion, allowing users to provide answers in natural language, ask for clarification, or request assistance. The GUI interface 118 displays the most contextually relevant form or form section based on ongoing chat inputs. Both interfaces are synchronized in real-time such that changes in one interface are immediately reflected in the other.

In some embodiments, the conversational AI assistant (AA) executes locally and/or remotely to facilitate data gathering, guide the user through form workflows, and escalate the session to a human assistant (HA) when necessary. The AA analyzes user responses using natural language processing and intent classification, ensuring that form fields are completed in a user-centric, non-linear fashion. The HA may intervene during the session or after detecting that the AA requires support to ensure successful form submission.

In some embodiments, computing component 102 may include one or more distributed applications implemented on client computing device 110 (e.g., conversational AI-driven form optimization application 114) as client applications.

### AI Assistant

In some embodiments, a conversational AI assistant may be provided by the distributed conversational AI-driven form optimization application 112. For example, the AI assistant may interact with users through natural-language conversation via a chat interface of the form optimization application 112, guiding them through the process of completing complex electronic forms. In some embodiments, an automated assistant may be implemented by an assistant provider that is distinct from the provider of the underlying form optimization platform, and may be integrated to operate seamlessly within the application.

In some embodiments, an automated software assistant ay be incorporated into the conversational AI-driven form optimization application 114 running on the client computing device 110. The AI assistant interacts with users (e.g., user 109) through a conversational interface, assisting in the collection of data necessary to complete electronic forms (e.g., mortgage applications). This interaction is supported by the conversational AI-driven form optimization application 112, which resides on the backend form optimization server 102. The server processes conversational inputs, context, and workflow logic to send relevant prompts, clarifications, or form updates to the user through the chat interface. In some embodiments, the automated assistant may be provided by a third-party service and integrated into the system, thereby enhancing the user experience by delivering personalized, real-time assistance during the form completion process.

The AI assistant is configured to parse user responses in real time, determine intent, and generate context-aware prompts and clarifications. Based on conversational flow and system logic, the assistant dynamically selects and renders relevant form sections in the graphical user interface (GUI), ensuring that users receive immediate and contextually accurate feedback and form progression. The AI assistant may also handle formatting corrections, autofill opportunities, and validation prompts during user interaction.

In some embodiments, the AI assistant may also support voice-based interactions, enabling users to complete forms through spoken conversation rather than typing. The system 100 may synthesize and output responses using distinct voice avatars, allowing users to distinguish between AI and human participants in the conversation. For example, the AI assistant may use a regionally localized synthetic voice (e.g., Southern accent for users in Texas), while human assistants may use a different avatarized voice to maintain a consistent and intuitive conversational experience. This voice interface allows users to provide spoken responses to form-related questions, which the system transcribes and categorizes for real-time integration with corresponding form fields.

The AI assistant continuously monitors interaction signals such as input delays, sentiment cues, and repeated clarification requests. If signs of user confusion or hesitation are detected, the system may adjust its conversational strategy—rephrasing questions, simplifying prompts, or offering summary guidance. These adaptive capabilities ensure users remain engaged and supported without requiring human intervention.

The assistant may also generate intelligent follow-up prompts or micro-workflows using predictive models trained on historical interaction data. These prompts may help preempt user drop-off by suggesting next steps, summarizing what has been entered, or nudging the user toward task completion. For example, if the user provides an address but omits a ZIP code, the assistant may ask, “Can you also provide the ZIP code for that address?”

In further embodiments, when the AI assistant determines that user responses are incomplete, ambiguous, or indicate hesitation or frustration, it may initiate a handoff to a human assistant (HA). This determination may be based on factors such as prolonged user response time, repeated failed validations, or emotional sentiment analysis. The HA may join the existing chat or voice interface without disrupting the user experience. During the handoff, the AI assistant may provide a summary of the user's progress and relevant context to the HA, enabling seamless assistance without requiring the user to repeat prior answers.

Additionally, the AI assistant may generate suggested follow-up prompts or workflows for the HA to use in assisting the user. These prompts may be selected using predictive models trained on prior interactions, workflow success rates, and user behavior patterns. For example, if a user appears confused about income documentation, the AI may recommend the HA ask, “Would you like help uploading your W-2 form or linking your payroll provider?” Such suggestions help human agents maintain consistency, reduce friction, and streamline the form completion process.

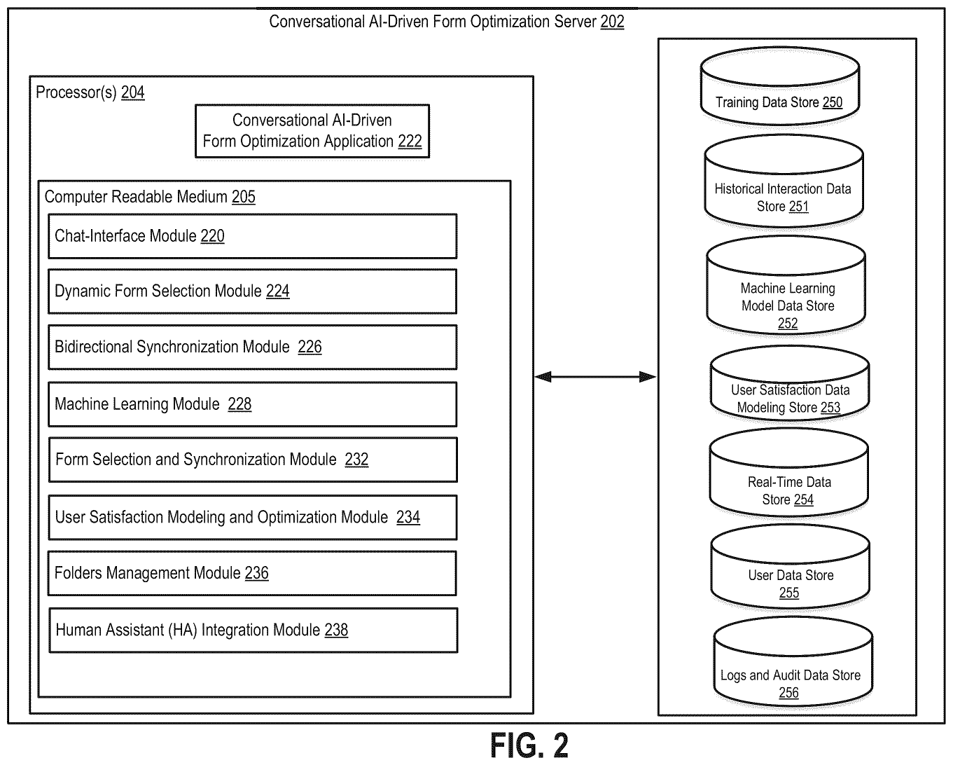

### FIG. 2

FIG. 2 illustrates the architecture of the conversational AI-driven form optimization server 202 of the conversational AI-driven form optimization system. For example, the system may be conversational AI-driven form optimization system 100 and the server may be conversational AI-driven form optimization server 102 illustrated in FIGS. 1A and 1B. The server 202 integrates various modules designed to enable natural language interactions, dynamic form selection, user satisfaction modeling, and bidirectional synchronization of chat and form data. The server 202 communicates with client computing devices, such as client device 110, over a network to facilitate seamless and intelligent form completion processes.

### Modules Overview

As illustrated in FIG. 2, the form optimization server 202 includes a processor 204 configured to execute instructions stored in a machine-readable medium 205. These instructions implement various modules and functions, including: a user interface module 220, dynamic form selection module 224, bidirectional synchronization module 226, form selection and synchronization control module 232, user satisfaction modeling and optimization module 234, folder management module 236, and human assistant integration module 238.

In some embodiments, the user interface module 220 manages the dual-interface experience for users by integrating a conversational chat window and a dynamic graphical form display within a split-screen layout. This module handles natural language interactions, surfacing contextually relevant questions from the AI assistant (AA), while simultaneously rendering the appropriate form sections based on those questions. It supports real-time updates, form previews, tooltip rendering, and dynamic input validation. The interface adapts based on the user's engagement level and context, enhancing accessibility and user control. Manages the conversational UI and the graphical form interface, ensuring synchronized and context-sensitive form rendering.

In some embodiments, the dynamic form selection module 224 uses trained transformer-based NLP and machine learning models to identify which section of a multipage or multi-topic form should be shown at any given time. It analyzes conversational history, contextual keywords, prior selections, and confidence levels to dynamically determine which form fields are relevant. The module incorporates a scoring function to prioritize display order and can surface only critical form components depending on user state or role (e.g., borrower vs. co-applicant). Uses trained machine learning models to predict and select the next most relevant form section based on conversation history, input context, and user metadata.

In some embodiments, the bidirectional synchronization module 226 maintains consistent and real-time linkage between chat inputs and the form view. When a user enters data in chat, the form interface is instantly updated and vice versa. Synchronization is achieved using a hybrid WebSocket and RESTful architecture, with message queues to handle conflict resolution and update sequencing. This module also interfaces with the session manager to preserve state across reloads, navigation events, or device transitions. Maintains real-time data consistency between chat and GUI. Any field modified in one interface triggers updates in the other.

In some embodiments, the form selection and synchronization control module 232 oversees coordination between modules 224 and 226 to ensure the correct sequence of form display and updates. It manages race conditions, resolves simultaneous input collisions, and guarantees that user edits or prompts do not overwrite prior changes. This control layer enforces consistency rules, manages form locking mechanisms, and tracks section completeness to inform dynamic routing logic within the conversation. Coordinates between selection and synchronization processes to avoid conflicts and ensure form state continuity.

In some embodiments, the user satisfaction modeling and optimization module 234 computes a dynamic satisfaction index using machine learning models that analyze both quantitative and qualitative user behavior. Metrics such as response latency, message sentiment, correction frequency, and time-on-task are continuously evaluated. The system uses these insights to adjust the complexity, sequence, or delivery format of subsequent prompts, and can re-prioritize form field presentation to mitigate user frustration. The satisfaction index also contributes to decisions about triggering human assistant engagement, altering the interface presentation (e.g., simplifying or expanding form sections), or pausing and resuming session workflows depending on the user's stress or disengagement indicators. In some embodiments, the user satisfaction modeling and optimization module 234 computes a satisfaction index based on metrics such as interaction delay, edit frequency, and help requests. This satisfaction index may be used to optimize workflow and prompt sequencing.

In some embodiments, the folder management module 236 detects, creates, and organizes hierarchical data structures associated with user inputs such as loan numbers, bank accounts, and document uploads. The module enables intuitive navigation through breadcrumb navigation bar representations and facilitates drag-and-drop association of inputs or files with the correct record context. It learns relationships between data entities over time and can auto-suggest folder structures based on prior user behavior. In some embodiments, the folder management module 236 also interacts with the session management subsystem to preserve folder state and document paths during session persistence and across multiple devices. In some embodiments, the folder management module 236 may detect and organize documents or inputs into related folder structures (e.g., based on loan number or bank account number, or any such similar data point). By virtue of organizing documents in related folder structures enables breadcrumb navigation bar navigation and document-path association.

The human assistant integration module 238 facilitates real-time escalation and coordination with a human assistant (HA) when the AI assistant identifies uncertainty, user frustration, or workflow bottlenecks. This module interacts with the user satisfaction modeling module 234 and bidirectional synchronization module 226 to determine when escalation is needed. It provides the HA with summarized context including user inputs, flagged issues, recent form modifications, and AI-suggested prompts. It further supports personalized assistance by enabling the use of voice avatars and HA-specific templates to maintain conversation continuity and support seamless transitions. Monitors the session context and user satisfaction score to determine if and when escalation to a human assistant is necessary. It provides the HA with a summarized snapshot of recent activity, pending inputs, and confidence metrics. The module includes templated response suggestions, handoff continuity indicators, and voice avatar controls if voice interaction is in use. HAs can assume control seamlessly and return the session back to the AA once resolved, with changes reflected in both chat and form logs. Monitors for conditions requiring escalation and facilitates HA handoff with full session state and AI-suggested prompts.

The form optimization system also leverages a set of data stores, each serving a specialized function. These include: a training data store 250, a historical interaction data store 251, a machine learning model data store 252, a user satisfaction index modeling store 253, a real-time data store 254, a user data store 255, and a logs and audit data store 256.

The training data store 250 contains annotated user interaction logs used to train predictive and classification models for intent recognition and form selection.

The historical interaction data store 251 maintains prior chat histories, field completion patterns, and navigation logs. This data improves adaptive guidance accuracy over time.

The machine learning model data store 252 houses model weights, configurations, hyperparameters, and metadata. This store is referenced by multiple modules during model inference and retraining operations.

The user satisfaction index modeling store 253 stores satisfaction index scores, satisfaction labels (predicted vs. confirmed), and the associated contextual factors for each session.

The real-time data store 254 tracks current user sessions, in-progress form data, temporary user edits, and timestamps.

The user data store 255 contains structured data tied to a specific user, such as personal information, loan identifiers, attached documents, and field metadata.

The logs and audit data store 256 logs every significant system action, including model triggers, user interface events, assistance handoffs, and data state transitions. These logs support compliance, debugging, and system evaluation tasks.

Together, these modules and data stores provide a robust infrastructure for managing adaptive, AI-powered form workflows. The architecture allows users to complete complex forms with greater accuracy, fewer interruptions, and personalized guidance tailored to their conversational context and form-specific goals.

As used herein, a “database” refers to any suitable type of database or storage system for storing data. A database may include centralized storage devices, a distributed storage system, a blockchain network, and others, including a database managed by a database management system (DBMS). In some embodiments, an exemplary DBMS-managed database may be specifically programmed as an engine that controls organization, storage, management, or retrieval of data in the respective database. In some embodiments, the exemplary DBMS-managed database may be specifically programmed to provide the ability to query, backup and replicate, enforce rules, provide security, compute, perform change and access logging, or automate optimization. In some embodiments, the exemplary DBMS-managed database may be chosen from Oracle database, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, or objects. In some embodiments, the exemplary DBMS-managed database may be specifically programmed to include metadata about the data that is stored.

### Bidirectional Synchronization Module 226

As alluded to above, the bidirectional synchronization module 226 ensures consistency between the chat-based AI interface and structured form fields through an event-driven synchronization mechanism. The synchronization module 226 continuously monitors user interactions and dynamically updates both the chat and form interface to reflect new inputs. For example, updates in one interface are propagated in real time to the other interface through event-based messaging protocols. Additionally, the system 100 introduces hierarchical folders, enabling structured document handling. Loan numbers, bank accounts, and supporting documents are treated as structured objects, where AI dynamically categorizes them into a hierarchical folder system. Users can drag and drop elements to associate them with existing folders, reinforcing AI-driven organization. The system further supports title bar navigation, allowing users to switch between loan-related objects (e.g., toggling between loan numbers, bank accounts, and property records) without disrupting workflow continuity.

### User Satisfaction Modeling and Optimization Module 234

The user satisfaction modeling and optimization module 234 is configured to execute machine learning algorithms that compute a satisfaction index in real time based on various metrics. These include but are not limited to user completion time, help-request frequency, interaction cadence, and the number of back-and-forth corrections. The system uses this index to guide downstream form presentation and prompt adaptation. For instance, if the index drops below a threshold, the system may reprioritize form fields, rephrase prompts to simplify comprehension, or escalate the session to a human assistant.

In some embodiments, the system utilizes machine learning models executed on a computing processor to analyze chat interactions and dynamically adjust form selection and user guidance. A classification algorithm processes user responses to identify key variables, which are then mapped to predefined form fields. The NLP engine performs intent recognition and entity extraction to ensure that responses are categorized correctly. A ranking model, trained on historical interactions, determines the likelihood that a given form section is relevant based on prior user behaviors.

The user satisfaction modeling and optimization module 234 utilizes machine learning models executed on a computing processor to analyze chat interactions and dynamically adjust form selection and user guidance. For example, a classification algorithm may be used to process user responses to identify key variables, which are then mapped to predefined form fields. Similarly, the NLP engine may be used to perform intent recognition and entity extraction to ensure that responses are categorized correctly. Finally, a ranking model, trained on historical interactions, is utilized to determine the likelihood that a given form section is relevant based on prior user behaviors.

To optimize form selection and user satisfaction, the user satisfaction modeling and optimization module 234 may be configured to employ a machine learning-driven user satisfaction index, calculated based on factors such as time spent, form complexity, and the number of repeated fields. The AI models utilized by the user satisfaction modeling and optimization module 234 may adapt dynamically to user behavior, reducing redundant questions, adjusting question sequencing, and pre-filling known values where applicable.

The AI assistant utilizes reinforcement learning models to continuously refine workflow efficiency, identifying bottlenecks where users are likely to abandon the form. The optimization process includes fine-tuning question ordering, refining chat-based explanations, and integrating predictive recommendations based on historical data. The system's learning pipeline incorporates real-time feedback loops where adjustments are made dynamically based on in-session user engagement patterns.

The AI also ensures seamless interaction between structured form fields and chat-based responses. The integration of natural language processing (NLP), decision trees, and symbolic logic models enables contextual understanding of user inputs, reducing ambiguity and improving data accuracy. A rule-based validation system checks inputs against pre-defined business logic, preventing inconsistent or incorrect submissions.

To ensure real-time synchronization, the bidirectional synchronization module 226 employs WebSocket-based bi-directional data streaming that updates form values dynamically based on chat input. Updates to structured fields in the form generate corresponding chat messages to keep the user informed, and AI-powered data reconciliation ensures that changes do not introduce inconsistencies.

The system utilizes machine learning models executed on a computing processor to analyze chat interactions and dynamically adjust form selection and user guidance. A classification algorithm processes user responses to identify key variables, which are then mapped to predefined form fields. The NLP engine performs intent recognition and entity extraction to ensure that responses are categorized correctly. A ranking model, trained on historical interactions, determines the likelihood that a given form section is relevant based on prior user behaviors.

Additionally, individual form experiences are optimized for users based on a user satisfaction index, which is dynamically calculated to represent the overall satisfaction of users completing forms. Guidance quality is another determinant of user satisfaction. Users benefit from clear instructions, reduced redundancy, and real-time assistance. The system optimizes guidance by dynamically generating tooltips, instructional overlays, and real-time validation prompts to enhance the user experience.

Machine learning methods assess the user satisfaction index by mapping independent factors, such as completion time and number of required documents, to dependent variables, such as user retention and form submission rates. The system continuously refines its mapping using iterative model training based on historical user interactions.

To optimize form guidance, the AI assistant adapts dynamically by eliminating redundant questions, minimizing repeated information requests, and customizing question order, allowing users to complete sections in a personalized sequence. The system further predicts user frustration based on interaction patterns, triggering alternative workflows or offering additional explanations. The UI dynamically adjusts elements to emphasize critical fields and minimize unnecessary clutter.

The system further includes adaptive error correction mechanisms, reducing the likelihood of form abandonment due to incomplete or misunderstood fields. The AI uses symbolic logic, decision trees, and regression models to correct errors dynamically while maintaining accurate record-keeping. The system ensures that errors identified in earlier form sections do not propagate to later interactions, allowing users to revise and confirm responses seamlessly.

The system utilizes machine learning models executed on a computing processor to analyze chat interactions and dynamically adjust form selection and user guidance. A classification algorithm processes user responses to identify key variables, which are then mapped to predefined form fields. The NLP engine performs intent recognition and entity extraction to ensure that responses are categorized correctly. A ranking model, trained on historical interactions, determines the likelihood that a given form section is relevant based on prior user behaviors.

Additionally, individual form experiences are optimized for users based on a user satisfaction index, which is dynamically calculated to represent the overall satisfaction of users completing forms. The index quantifies the impact of various independent factors, including time investment (e.g., the duration a user spends completing a form affects perceived difficulty), Convenience (e.g., requests for third-party documents or external verifications impact user satisfaction, form complexity (e.g., the number and type of fields vary depending on loan type, loan amount, and financial profile), guidance quality (e.g., users benefit from clear instructions, reduced redundancy, and real-time assistance).

Machine learning methods, including neural networks, evolutionary algorithms, and fuzzy logic models, assess the user satisfaction index by mapping independent factors (e.g., completion time, number of required documents) to dependent variables (e.g., user retention, form submission rates). The system continuously refines its mapping using iterative model training based on historical user interactions.

To optimize form guidance, the AI assistant adapts dynamically by eliminating redundant questions, minimizing repeated information requests, customizing question order, allowing users to complete sections in a personalized sequence, predicting user frustration based on interaction patterns, triggering alternative workflows or offering additional explanations, and adjusting UI elements dynamically, emphasizing critical fields and minimizing clutter.

The system further includes adaptive error correction mechanisms, reducing the likelihood of form abandonment due to incomplete or misunderstood fields. The AI uses symbolic logic, decision trees, and regression models to correct errors dynamically while maintaining accurate record-keeping.

The system utilizes machine learning models executed on a computing processor to analyze chat interactions and dynamically adjust form workflows. A classification algorithm processes user responses to identify key variables, which are then mapped to predefined form fields. The NLP engine performs intent recognition and entity extraction to ensure that responses are categorized correctly. A ranking model, trained on historical interactions, determines the likelihood that a given form section is relevant based on prior user behaviors.

The disclosed system improves the user experience by providing conversational form completion—instead of following a rigid structure, the AI-powered assistant (AA) interacts with users through natural-language dialogue, eliciting information based on the conversation flow rather than enforcing a strict sequence. Furthermore, the system provides dynamic form selection capabilities. For example, the system predicts and displays the most relevant form or section based on ongoing conversation context, ensuring that the user sees only the information relevant to their current discussion. Finally, the system offers intelligent user guidance that simplifies the process by recognizing when a user is struggling and offering real-time assistance, providing explanations and clarifications about requested information, and inviting a human assistant (HA) when the user requires additional support.

### AI Assistant Support

In some embodiments, the AI assistant operates as a coordinated agent supported by multiple backend modules, including the dynamic form selection module 224, bidirectional synchronization module 226, form selection and synchronization control module 232, and user satisfaction modeling module 234. These modules work together to determine which form sections to render, synchronize inputs across interfaces, manage state transitions, and assess the user's engagement level and emotional context.

The modules of the conversational AI-driven form optimization system ensure that the AI assistant is continuously informed by interaction data such as response latency, clarification requests, and sentiment cues. For example, by using insights from the user satisfaction modeling module 234, the system may adapt the prompt complexity, reorder workflow steps, or pause a session when user frustration is inferred. These adaptations occur autonomously without requiring human input, allowing the assistant to dynamically optimize form completion.

### Folders Management Module 236

In some embodiments, the folder management module 236 implements this functionality, tracking user interactions and folder associations via persistent data models. This module interacts with the user data store 255 and logs and audit data store 256 to record metadata and file associations in real time. It ensures that hierarchical navigation remains synchronized with both the graphical and conversational interfaces. For example, when a user uploads a new document and associates it with a specific loan number via drag-and-drop, the conversational AI-driven form optimization system automatically updates the folder structure in the UI and generates a corresponding chat message confirming the upload.

Similarly, if a user references or clicks on a document in chat, the form display will scroll to the associated section of the folder or underlying structured form, providing contextual continuity across both the chat and graphical interfaces.

The AI assistant uses message queues (Kafka, RabbitMQ) and real-time indexing to efficiently process updates between the chat module and form fields. A stateful session manager ensures that partially completed forms are preserved and retrieved in real-time, preventing data loss or duplication.

The system maintains real-time consistency between the chat-based AI interface and structured form fields through an event-driven synchronization mechanism. The bidirectional synchronization module 226 continuously monitors user interactions and dynamically updates both the chat and form interface to reflect new inputs.

To achieve seamless interaction, the system implements the following technical improvements. Real-time UI state binding ensures the split-screen UI updates dynamically based on conversational context, ensuring that the most relevant section of the form remains visible. RESTful API & WebSocket integration provides updates to form values propagate instantly to the chat interface and vice versa, eliminating inconsistencies. Event-driven architecture which allows user interactions to trigger event-based updates to optimize responsiveness, reducing computational overhead and latency. Finally, database-backed form caching including persistent storage ensures that form state is saved securely across multiple sessions and devices, enabling seamless resumption of partially completed workflows.

By implementing a predictive ranking model, the system prioritizes user interactions and anticipates next-step recommendations, improving overall engagement and reducing form abandonment rates.

The bidirectional synchronization module 226 running on the backend server ensures that updates in the graphical form and chat interface remain consistent. The system performs real-time data binding, where form inputs are stored in an indexed database and retrieved when generating corresponding chat messages. When a form field is modified, a WebSocket-based communication protocol updates the chat interface instantaneously. Conversely, when a user provides data in chat, a REST API call is triggered to populate the relevant form fields on the UI.

The chat interface and the graphical form are automatically synchronized, ensuring consistency between conversational inputs and structured data. When a user modifies a field in the form, the system generates a real-time chat message reflecting the update. Conversely, when a user provides information in chat, the corresponding form field is automatically populated. The split-screen layout ensures that users can interact with both interfaces simultaneously, maintaining workflow continuity.

### Human Assistant Integration Module 238

While the AI assistant handles most interactions, the system detects when human assistance is needed. The HA may take over the conversation when the user is struggling, provide contextual guidance based on AI-generated suggestions, modify structured form data to ensure accuracy, and/or perform such similar functions.

The HA integration module 238 works in coordination with the user satisfaction modeling module 234 and bidirectional synchronization module 226 to determine the optimal time for escalation. It uses real-time sentiment analysis, interaction delays, and confidence thresholds in parsed intent to trigger a human takeover. Once the HA is engaged, the system provides them with a contextual summary of the conversation, recent form modifications, flagged uncertainties, and suggested follow-up prompts, allowing the HA to seamlessly support the user.

In some embodiments, the AI assistant may also suggest follow-up questions or conversation templates for the HA to send, optimizing the experience while maintaining a consistent voice and improving resolution speed. The HA may utilize voice avatars to distinguish themselves from the AI assistant when voice-based interaction is enabled, preserving transparency for the user.

### Session Persistence Folder Navigation & Secure Data Handling

The system employs a multi-layered security and session management framework to protect sensitive user data, support seamless workflow continuation, and comply with enterprise and regulatory standards. Session state is maintained through encrypted key-value storage, allowing users to pause and resume form workflows across devices without losing progress. All in-progress sessions are encrypted using AES-256 and protected using secure token-based authentication to ensure user-specific access. This framework is orchestrated by the AI-powered session management subsystem, which coordinates with the bidirectional synchronization module 226 and user satisfaction modeling module 234 to dynamically resume form workflows based on timestamped interaction logs and inferred user state. Chat and form interfaces are updated accordingly to avoid redundant inputs and preserve task continuity.

The system also includes intelligent folder navigation supported by the folder management module 236. When the AI assistant detects that a user-provided value (e.g., a loan number) represents a structured object, it initiates a dynamic folder structure in the UI. These folders are displayed in a breadcrumb-style navigation bar, allowing users to toggle between loan-related entities such as bank accounts, uploaded documents, and transaction histories. Users can switch between application contexts, review documents, and continue form inputs within the appropriate folder scope.

To protect sensitive user information during interaction, the system uses end-to-end encryption (E2EE) and secure token protocols. All chat interactions are encrypted before transmission, and sensitive fields such as Social Security numbers or account details are automatically masked in the chat log while remaining visible in the form interface when appropriate. These safeguards are enforced centrally through the platform's security control layer.

In some embodiments, the system employs federated machine learning models to allow personalization without centralized storage of personally identifiable information (PII). These models operate within secure enclaves and adapt to user behavior while maintaining privacy. For fraud prevention, the system may deploy anomaly detection models trained to identify irregular interaction patterns or unauthorized access attempts.

The session management framework further includes intelligent resumption logic. It reconstructs form state and conversational history using timestamped logs and predictive modeling. When a returning user resumes a session, the system restores the user to their last active context—including populated form fields, folder view, and recent prompts—without requiring re-entry of previously collected data.

To enhance efficiency, the system integrates predictive preloading. This feature identifies likely-required documents or fields based on historical user interactions and retrieves or prepopulates them accordingly. The AI model draws from the user's session history, prior form completions, and similar workflow sequences to streamline progression and reduce manual input.

### Intelligent Quick Requests & Categorization

The system introduces intelligent quick request elements that are contextually linked to specific form fields. These elements are presented as selectable prompts or icons within the chat interface, allowing users to respond with structured data more efficiently. When a user selects or interacts with a quick request, the system automatically maps the response to the associated field in the form interface and highlights the corresponding section in the graphical UI.

If a user provides input outside the expected sequence—or in a conversationally ambiguous format—the system leverages contextual inference models (e.g., via the dynamic form selection module 224 and user satisfaction module 234 to accurately categorize the response. The AI then assigns the input to the appropriate form field, preserving data integrity and minimizing the need for re-entry.

### Emotional State Recognition & Adaptive Assistance

The AI assistant continuously evaluates user sentiment based on linguistic cues, typing delays, backtracking behavior, and interaction rhythm. These indicators are used to generate a real-time engagement score or emotional state signal, which is processed by the user satisfaction modeling module 234.

Based on these insights, the system can adapt its interaction strategy. For example, it may simplify or rephrase prompts, reduce the number of visible fields, or suggest taking a break. In cases of elevated frustration or uncertainty, the system may trigger handoff protocols supported by the human assistant integration module 238, allowing a human assistant to step in with awareness of the user's emotional state and workflow context.

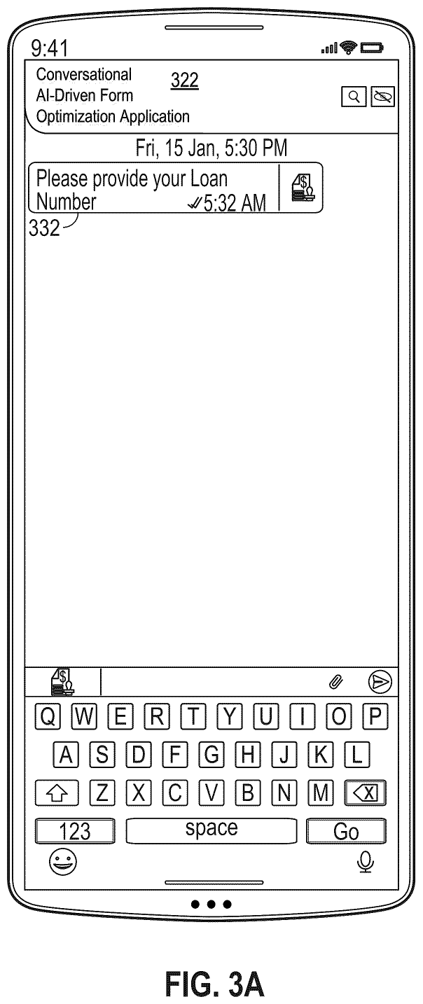

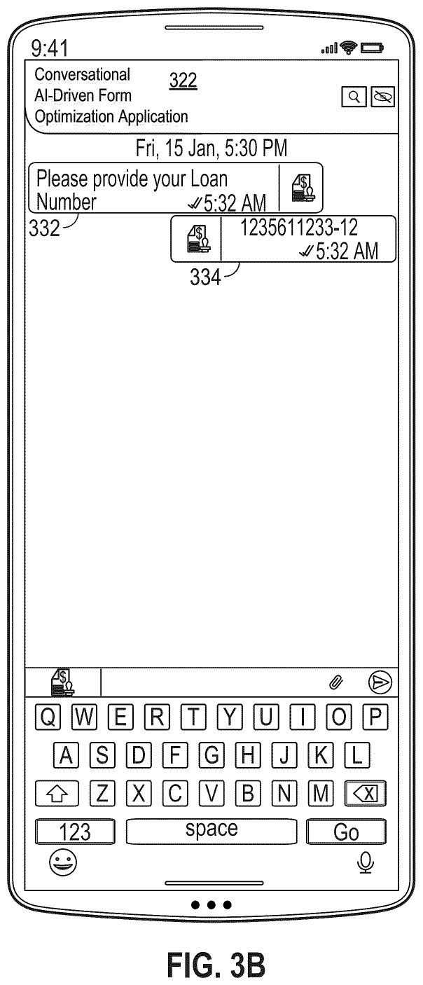

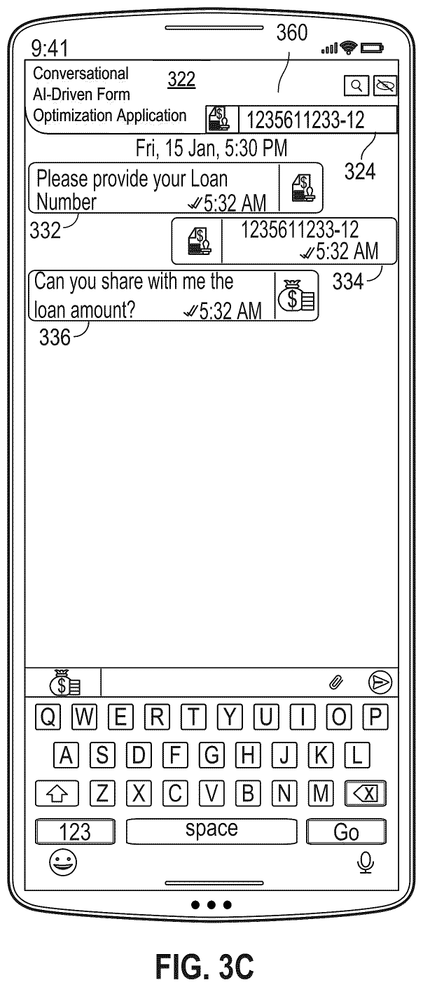

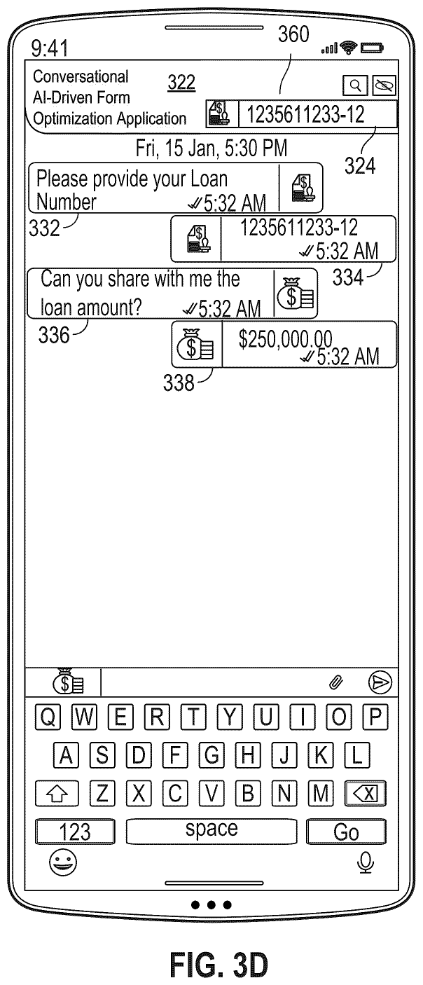

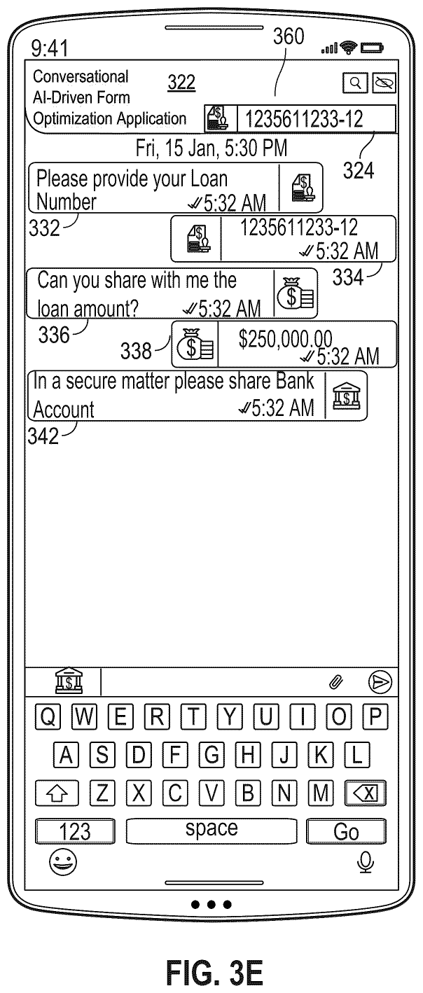

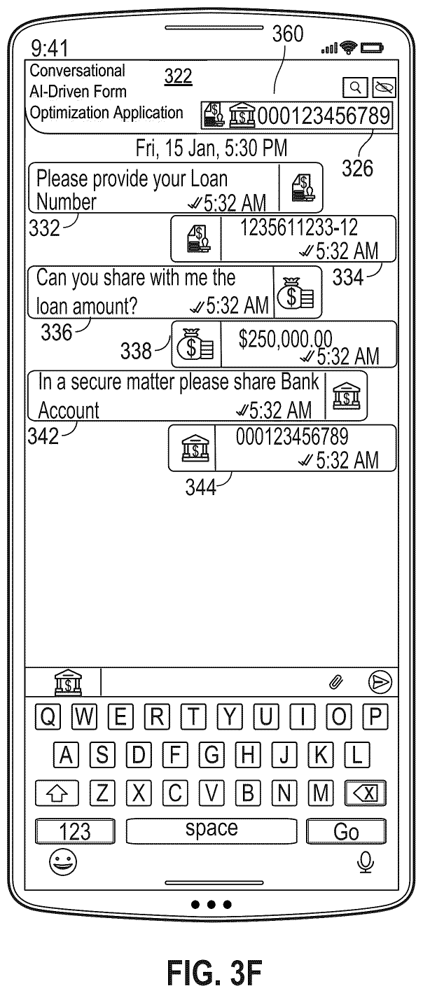

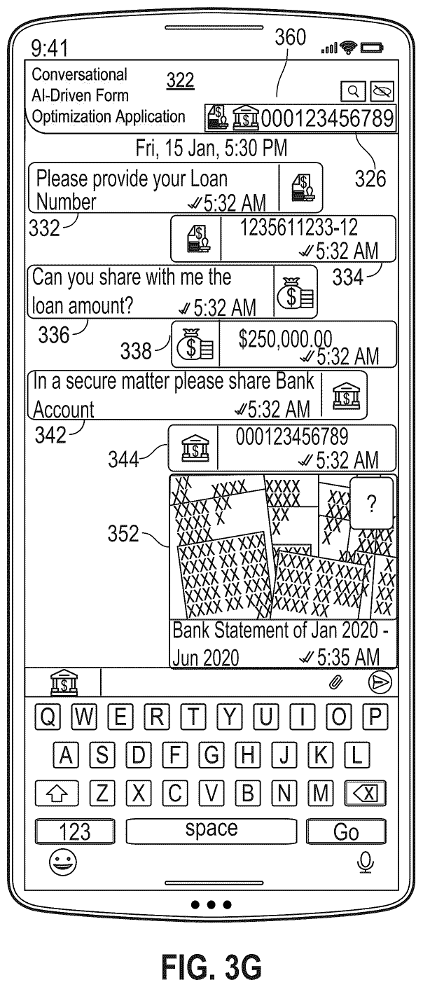

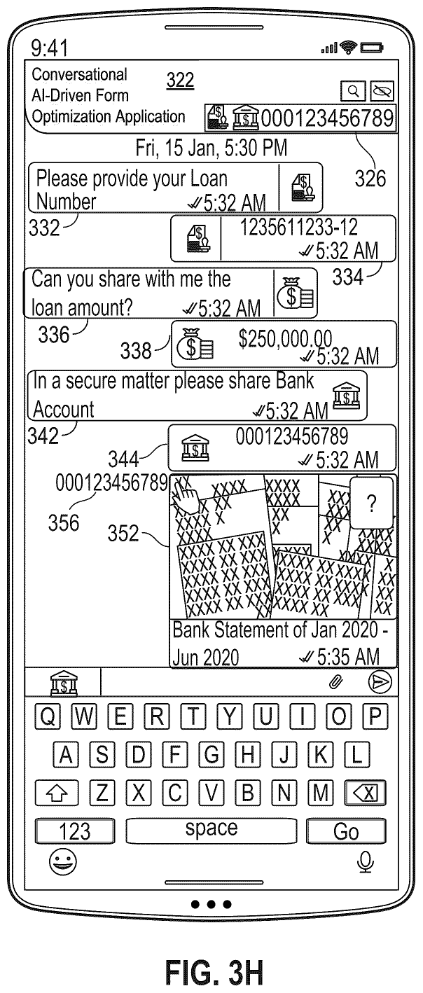

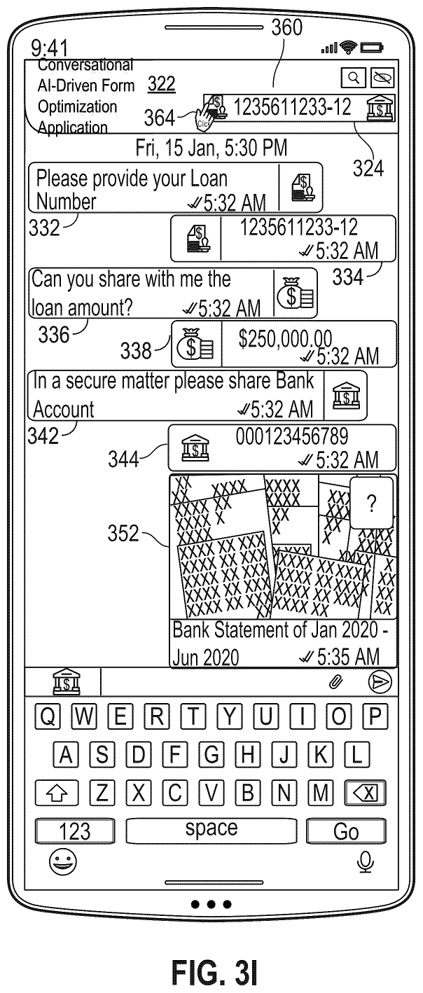

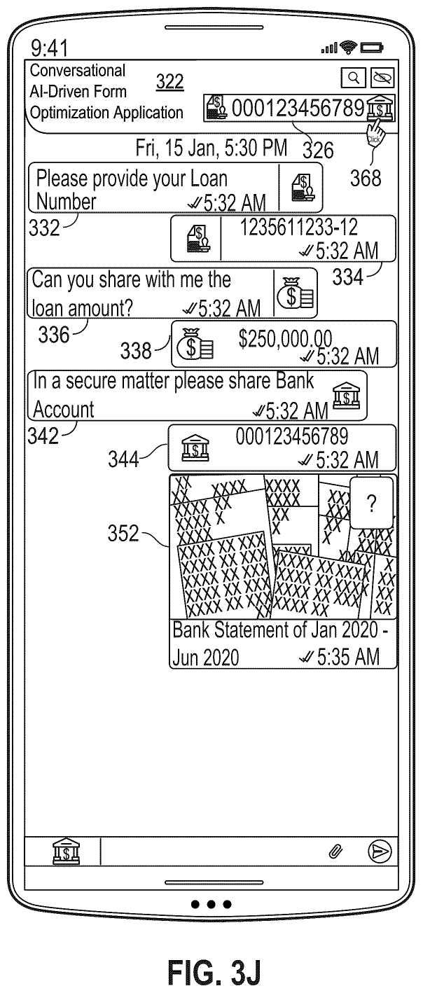

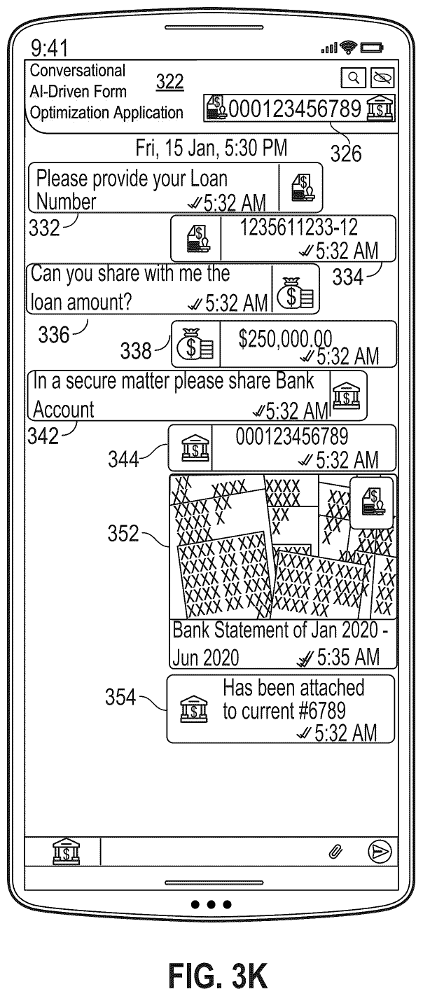

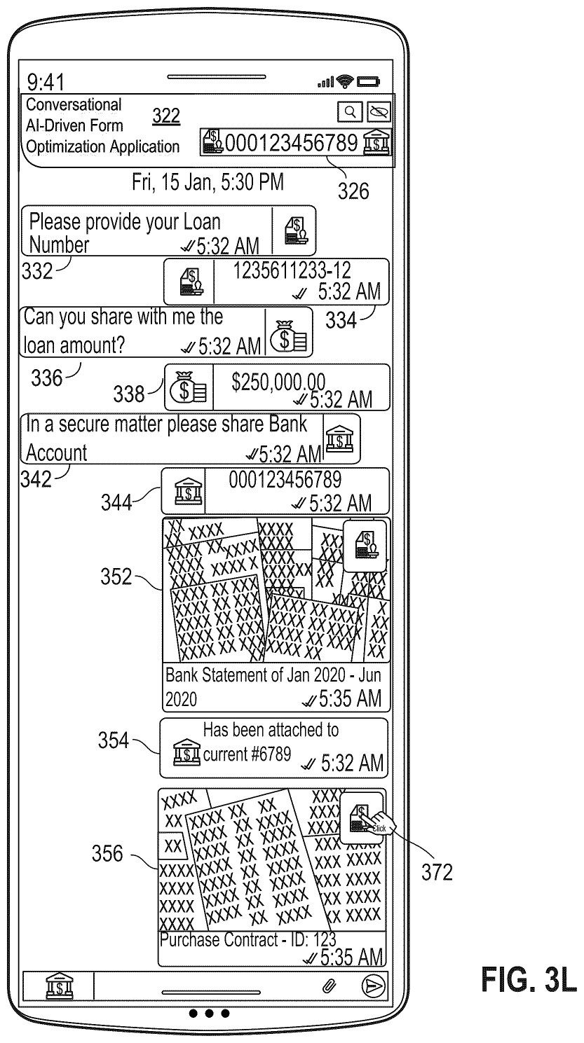

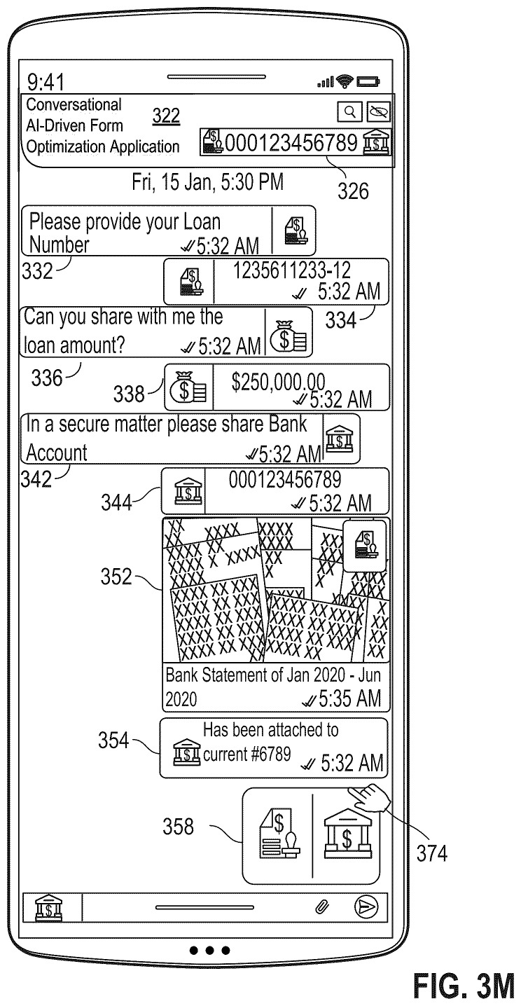

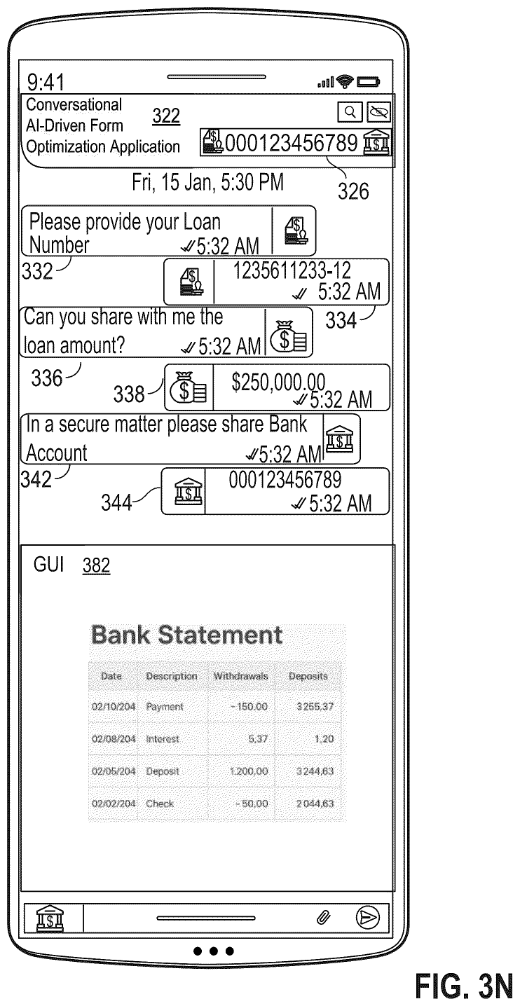

### FIGS. 3A-3M

FIGS. 3A-3M illustrate the real-time interaction between folder recognition, UI updates, drag-and-drop logic, metadata tagging, and conversational context-functionality implemented within the folder management module 236 and synchronized using the bidirectional synchronization module 226 of system 100.

FIG. 3A illustrates the AI assistant prompting the user with a prompt 332 to provide an identifier (e.g., loan number) associated with an existing loan application within the chat interface of conversational AI-driven form optimization application 322.

FIG. 3B illustrates the user entering a loan number into the chat interface of conversational AI-driven form optimization application 322 as input 334 (e.g., ‘1235611233-12’), in response to the prompt 332 in FIG. 3A. The system identifies the input as a structured data object and uses it to create a folder context associated with the user's session. For example, the AI assistant parses the message, identifies the token as a loan identifier using keyword proximity and format validation (e.g., 10+ digit numeral), and maps it to a new structured folder instance in memory. In response to a prompt in the chat interface, the system parses the message, identifies it as a potential folder identifier, and associates it with metadata such as a creation timestamp, user context, and the originating chat message. These metadata tags are used to manage folder state and link the identified object to future interactions. The system parses the input and recognizes the string as a structured identifier suitable for folder creation.

FIG. 3C shows the interface dynamically updating the header bar to display the loan number ‘1235611233-12’ as a persistent folder label 324 displayed in the breadcrumb navigation bar 360. This visual cue confirms that the system has recognized the user's input as a meaningful data object. The loan number becomes the primary context for all subsequent form and document interactions, allowing the system to scope new data entries and documents to the corresponding folder. The folder label in the header bar also functions as a navigation control, enabling the user to quickly access any content—such as form sections or attached documents—associated with the recognized loan folder.

Furthermore, FIG. 3C depicts the AI assistant prompting the user with a prompt 336 to provide the loan amount associated with the loan number within the chat interface of the conversational AI-driven form optimization application 322.

FIG. 3D depicts a user entering a loan amount (e.g., ‘$250,000.00’) as input 338 into the conversational chat window of the user interface of the conversational AI-driven form optimization application 322. The system categorizes the input under the active folder and reflects the value in the form UI. For example, the system identifies the input as a numerical value representing a loan attribute, which it automatically categorizes under the active folder context (e.g., Loan ‘1235611233-12’). The amount is then stored within the structured data store associated with that folder and rendered in the corresponding location in the real-time graphical form display, keeping both views synchronized.

FIG. 3E depicts the AI assistant prompting the user with a prompt 342 to share their bank account number within the conversational AI-driven form optimization application 322.

FIG. 3F shows the user providing a bank account number (e.g., ‘000123456789’), as input 344, in the chat interface of the conversational AI-driven form optimization application 322 in response to the prompt 342 in FIG. 3E. Upon recognizing the input as financial data, the AI assistant masks the response in the chat history for security and privacy compliance.

Simultaneously, the system creates a subfolder within the active folder structure 326 (e.g., adjacent to Loan ‘1235611233-12’) to represent the bank account context (e.g., Bank Account ‘000123456789’). This bank account subfolder becomes the scope for any related documents or further user inputs. The association is managed through folder context metadata, which is also used to organize and later retrieve all bank account-related information seamlessly within the user interface. However, the user can modify the parent-sub-folder relationship via drag and drop and change the order of the folders on the breadcrumb navigation bar and the system will learn relationships between objects this way.

Additionally, FIG. 3F illustrates the header navigation bar dynamically expanding to show a nested folder structure. The breadcrumb trail (e.g., Loan ‘1235611233-12→Bank Account 000123456789’) allows the user to visually track and navigate through associated subfolders within the folder hierarchy. This structure reflects relationships between entities such as loan numbers and linked bank accounts. Clicking on any part of the breadcrumb trail filters the view in both the chat interface and the graphical form, ensuring that only the messages, uploads, and inputs relevant to the selected branch are shown. This enables contextual continuity and streamlines access to complex, multi-layered application data.

FIG. 3G demonstrates the user dragging and dropping a PDF document 352 (e.g., Bank Statement January 2020-June 2020.pdf) from their desktop or file selection window into the designated area of the conversational AI-driven form optimization application 322 labeled with the Bank Account folder, ‘Bank Account 000123456789’ (e.g., folder 326 in the breadcrumb navigation bar 360). Upon detecting the drop event, the system initiates an upload workflow that scans the file name, extension, and metadata (such as document type, last modified date, and file origin) to auto-tag the document with the corresponding loan and subfolder context. This auto-tagging ensures the file is both indexed and retrievable from the appropriate folder, while also preparing a contextual confirmation message for the chat window.

FIG. 3G illustrates confirmation of a successful document upload that the user wants to be associated with the Bank Account folder 326 (e.g., ‘Bank Account 000123456789’). After the user drags and drops a document (e.g., ‘Bank Statement January 2020-June 2020.pdf’) into the active Bank Account folder 326, the system auto-tags it using folder-level metadata and displays a confirmation message in the chat interface. The message confirms the filename and the folder it was associated with (e.g., Bank Statement January 2020-June 2020.pdf’ successfully attached to Bank Account 000123456789’), providing visual feedback and establishing a traceable record of the upload event, as illustrated in FIG. 3K.

FIG. 3H depicts the folder hierarchy automatically updating to reflect the newly uploaded document. A new entry labeled “Bank Statement January 2020-June 2020.pdf” appears beneath the corresponding folder 326 (e.g., under ‘Bank Account 000123456789’). The visual folder path expands to include the document and the associated bank account number of older 365 (e.g., Bank Account 000123456789’), reinforcing the logical placement of the file within the structured folder hierarchy and enabling intuitive navigation across nested contexts.

FIG. 3I shows the user navigating across the folder hierarchy using the breadcrumb navigation bar 360. For example, when the user clicks (e.g., click illustrated as 364) on a folder label 324 (e.g., ‘Loan 1235611233-12’), the interface filters the form view and chat history to display only the content associated with that context. This includes attached documents, user inputs, and relevant AI prompts, enabling the user to focus on a specific portion of the mortgage application without losing conversational continuity.

Similarly, FIG. 3J shows the user navigating back to folder 324 (e.g., Loan ‘1235611233-12) from folder 326 (e.g., under ‘Bank Account 000123456789’) by clicking on the bank icon 326, click is illustrated as 368.

FIGS. 3L-3M show a document thumbnail that uses a flip animation to reveal metadata.

As shown in FIG. 3L, when a document (e.g., a purchase contract or bank statement) is uploaded and associated with a particular folder (e.g., loan number #6789), the system displays the document as a thumbnail card (e.g., element 356). The front of the card shows metadata including the document type, file name, timestamp, and optional user-provided notes. The front of the card displays a preview and filename (e.g., “Purchase Contract-ID: 123”), upload timestamp, and any user-provided notes (illustrated AS 356 in FIG. 3L), while the back shows thumbnail icons (illustrated AS 358 in FIG. 3LB). This is achieved by clicking 372 in FIG. 3L or 374 in FIG. 3M. This visual technique allows the user to audit and verify document location and relevance in real time, without disrupting the ongoing form completion flow.

To enhance usability, the thumbnail supports a flip animation triggered by tapping or clicking an icon (e.g., element 372 in FIG. 3L or 374 in FIG. 3M). Upon flipping, as shown in FIG. 3M, the card (in FIG. 3L) reveals additional document metadata, such as file path, association context, and document status, along with visual thumbnail icons (e.g., element 358).

This UI element enables the user to verify, audit, and interact with attached documents without interrupting the form completion process. The document preview remains within the conversational flow, preserving continuity across chat, form, and folder navigation layers. This is particularly useful in high-volume mortgage workflows where multiple supporting documents may be linked to a given form section or folder hierarchy.

FIG. 3N demonstrates the cross-interface synchronization in action. When the user clicks on a document name (e.g., “Bank Statement January 2020-June 2020.pdf”) from the chat interface, the graphical form UI 382 scrolls to the relevant section associated with that document (e.g., income verification). The corresponding form field is highlighted, and any related prompts or past responses are re-surfaced in the chat, maintaining workflow context and reducing friction.

### Exemplary Workflow

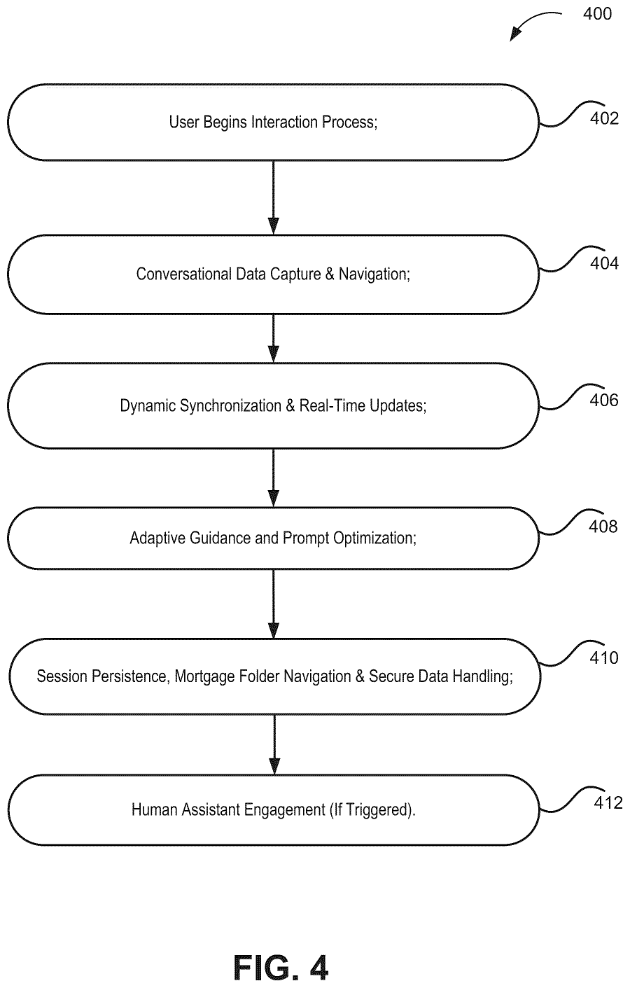

With reference now to FIG. 4, a flowchart illustrating an exemplary workflow and folder-based document structuring is shown in accordance with an illustrative embodiment. This unified example captures a full end-to-end interaction, showcasing dynamic form selection, intelligent guidance, real-time synchronization, and the option for secure session resumption or HA assistance. The workflow shown in FIG. 4 may be implemented in a computing component, such as, for example, AI-driven form optimization server 110 illustrated in FIGS. 1A-1B or server 202 in FIG. 2.

The process begins in step 402 when the user initiates the interaction with the AI assistant through the chat interface of conversational AI-driven form optimization application (e.g., application 114 illustrated in FIGS. 1A-1B). For example, the AI assistant may greet the user and ask a context-aware prompt such as “What is your purchase price?” Based on the response, the system performs real-time context prediction to identify and display the appropriate form section in the graphical user interface.

In step 404, the system captures user-provided data and performs context-sensitive navigation. The user may provide responses in natural language and in a non-linear order. The AI parses these responses, maps them to relevant form fields, and updates both the chat interface and form view in real time. If a structured identifier such as a loan number or account reference is detected, the system creates or associates it with a dynamic folder and updates the breadcrumb navigation bar accordingly.

In step 406, dynamic synchronization ensures consistency across the interface. When a user modifies a form field, the system generates a corresponding chat message to reflect the change. Conversely, chat-based entries populate the appropriate fields in the form UI. Bidirectional synchronization is achieved using a WebSocket-based event listener and RESTful API calls for high-speed propagation between components.

In step 408, the system provides adaptive guidance and prompt optimization. The AI assistant monitors engagement signals such as response latency, message edits, or sentiment markers. If the system detects hesitation, confusion, or frustration, it may rephrase prompts or escalate the session to an HA. The assistant also uses predictive models to generate tailored follow-up prompts to guide the user toward successful form completion.

In step 410, the system enables session persistence, folder navigation, and secure data handling. The session management subsystem—implemented either as part of the folder management module (e.g., module 236) or as a standalone layer—retains session state, partially completed fields, and chat history across devices. Bidirectional synchronization module 226 ensures consistency between chat and form interfaces during session resumption. The user satisfaction modeling and optimization module 234 monitors user signals and may trigger session pausing and resumption workflows based on satisfaction index thresholds. All session data is encrypted using AES-256 and protected using token-based authentication. Upon resumption, users are restored to their most recent context, including populated fields, folder hierarchy, and chat memory.

In step 412, if triggered, the system initiates human assistant (HA) engagement. The HA joins the session with full access to chat logs, recent edits, and form state. The system may provide suggested responses, highlighted priority fields, and other contextual indicators to help the HA respond efficiently and reduce user burden.

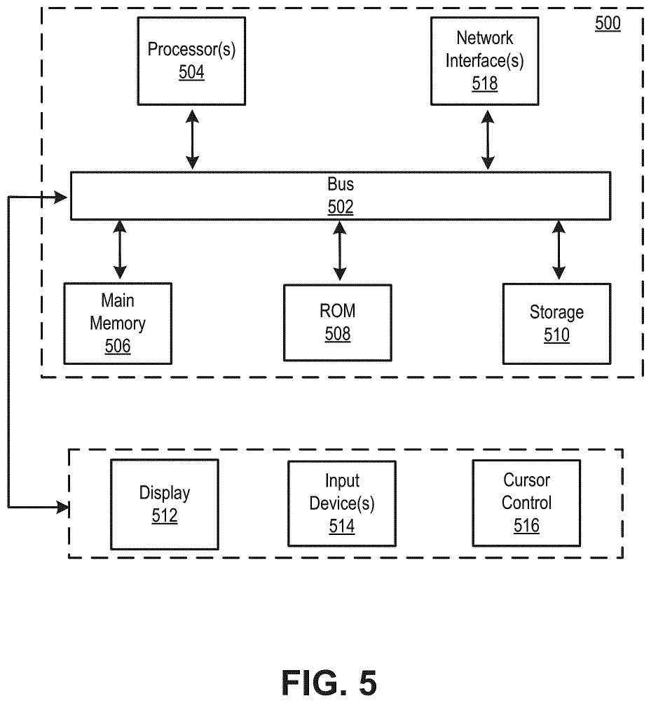

### Computing Module

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 5. Various embodiments are described in terms of this example computing module 500. After reading this description, it will become apparent to a person skilled in the relevant art how to implement the technology using other logical circuits or architectures.

FIG. 5 illustrates an example computing module 500, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALS, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the application using other computing modules or architectures.

Referring now to FIG. 5, computing module 500 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally. The bus 502 may also be connected to other components such as a display 512, input devices 55, or cursor control 516 to help facilitate interaction and communications between the processor and/or other components of the computing module 500.

Computing module 500 might also include one or more memory modules, simply referred to herein as main memory 506. For example, preferably random-access memory (RAM) or other dynamic memory might be used for storing information and instructions to be executed by processor 504. Main memory 506 might also be used for storing temporary variables or other intermediate information during execution of instructions to be executed by processor 504. Computing module 500 might likewise include a read only memory (“ROM”) 508 or other static storage device 510 coupled to bus 502 for storing static information and instructions for processor 504.

Computing module 500 might also include one or more various forms of information storage devices 510, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 510 might include other similar instrumentalities for allowing computer programs or other instructions or data to be loaded into computing module 500. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 500.

Computing module 500 might also include a communications interface or network interface(s) 518. Communications or network interface(s) interface 518 might be used to allow software and data to be transferred between computing module 500 and external devices. Examples of communications interface or network interface(s) 518 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 518 might typically be carried on signals, which can be electronic, electromagnetic (which includes optical) or other signals capable of being exchanged by a given communications interface. These signals might be provided to communications interface 518 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 506, ROM 508, and storage unit interface 510. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method comprising:
parsing, by a processor, a conversation workflow for completing an electronic form within a chat-based interface;
identifying, using a trained machine learning model, structured user inputs and predicting, based on conversation context, one or more relevant form sections;
selecting, based on the parsed conversation workflow and model prediction, a form or form section from a plurality of stored electronic forms;
displaying the selected form adjacent to the chat interface in a split-screen layout;
dynamically updating the displayed form based on real-time user chat inputs;
synchronizing chat inputs and form modifications bidirectionally, comprising:
(i) generating a chat message in response to a change in form data;
(ii) updating form fields in response to a change in chat message content; and
persisting form state and chat history across sessions to enable users to pause and resume workflow completion without data loss.

2. The computer-implemented method of claim 1, wherein parsing the conversation workflow comprises performing natural language understanding to extract user intent and conversational context.

3. The computer-implemented method of claim 1, wherein selecting the relevant form or form section comprises scoring candidate sections based on contextual relevance, user role, and prior inputs.

4. The computer-implemented method of claim 1, further comprising displaying a dynamic breadcrumb navigation bar that reflects folder associations based on recognized user inputs.

5. The computer-implemented method of claim 1, wherein structured user inputs include a loan number, account details, document attachments, or user-generated categorizations, and wherein the method further comprises creating a hierarchical folder associated with the loan number.

6. The computer-implemented method of claim 1, further comprising automatically associating uploaded documents with the active folder context based on user interaction or metadata inference.

7. The computer-implemented method of claim 1, wherein bidirectional synchronization is performed using a hybrid architecture comprising WebSocket-based event listeners and RESTful API endpoints.

8. The computer-implemented method of claim 1, wherein persisting form state further comprises encrypting session data using AES-256 and storing it in a secure, token-authenticated key-value store.

9. The computer-implemented method of claim 1, further comprising generating quick request prompts, each associated with a specific form field, and enabling user responses to be tagged and categorized accordingly.

10. The computer-implemented method of claim 1, further comprising detecting a user satisfaction index based on interaction metrics and dynamically modifying the form interaction sequence in response.

11. A computer-implemented system comprising:
a chat-based interface configured to receive natural language inputs from a user for completing an electronic form;
a graphical user interface configured to display one or more form sections adjacent to the chat-based interface in a split-screen layout;
a dynamic form selection module configured to select, based on parsed conversation context, a relevant form or form section from a plurality of stored electronic forms;
a bidirectional synchronization module configured to:
(i) update the form fields in response to user inputs in the chat-based interface; and
(ii) generate chat messages reflecting changes made to the form fields;
a session management subsystem configured to persist user inputs and chat history in real time, enabling users to pause and resume the form workflow across devices without data loss;
a processor coupled to a memory storing instructions that, when executed, cause the system to:
(i) identify structured user inputs including at least one of a loan number, account details, document attachments, or user-generated categorizations; and
(ii) update the graphical user interface and folder structure in response to the identified structured user inputs.

12. The system of claim 11, wherein the dynamic form selection module comprises a trained machine learning model configured to predict a next-relevant form section based on user input history, conversation context, or workflow progression.

13. The system of claim 11, wherein the bidirectional synchronization module comprises a hybrid communication architecture that includes WebSocket-based listeners and RESTful API endpoints for propagating updates between the chat-based interface and graphical user interface.

14. The system of claim 11, wherein the session management subsystem encrypts stored session data using AES-256 and secures access using token-based authentication.

15. The system of claim 11, wherein the processor is further configured to create a hierarchical folder structure in response to a recognized structured input, and to associate subsequent form entries or document uploads with the corresponding folder.

16. The system of claim 11, wherein the graphical user interface comprises a breadcrumb-style navigation bar for navigating between folders and subfolders associated with a loan application.

17. The system of claim 11, wherein the system is configured to detect user sentiment based on linguistic cues, typing delays, and message corrections, and to adjust prompt phrasing or interaction sequencing accordingly.

18. The system of claim 11, further comprising a satisfaction modeling module configured to compute a satisfaction index and trigger adaptive interface responses based on engagement or frustration levels.

19. The system of claim 11, wherein the system is configured to generate contextual follow-up prompts or quick request icons based on prior user interactions and predicted field relevance.

20. The system of claim 11, wherein the system is further configured to generate and display chat confirmations upon successful form updates, folder assignments, or document attachments.
